(19) United States
(12) Patent Application Publication
(10) Pub. No.: US 2026/0135032 A1
(43) Pub. Date: May 14, 2026

(54) METHOD AND APPARATUS FOR ASSEMBLING HALBACH ARRAY BY UTILIZING A PERMANENT MAGNET JIG DEVICE

(71) Applicants: Hyundai Motor Company, Seoul (KR); Kia Corporation, Seoul (KR)

(72) Inventor: Seongjun Park, Hwaseong-si (KR)

(21) Appl. No.: 19/306,413

(22) Filed: Aug. 21, 2025

(30) Foreign Application Priority Data
Nov. 8, 2024 (KR) 10-2024-0157700

(51) Int. Cl. H01F 41/00; H01F 41/02

(52) U.S. Cl. CPC H01F 41/005; H01F 41/0253

(57) ABSTRACT

A method for assembling Halbach array by utilizing a permanent magnet jig device may include inserting a magnet arrangement jig between an OD alignment jig including a plurality of permanent magnets disposed in a cylindrical form and forming a magnetic field in a radial direction and a tangential direction, and an ID alignment jig paired with the OD alignment jig, assembling a plurality of assembly magnets in an arrangement groove formed along an exterior circumference of the magnet arrangement jig according to an orientation of a Halbach array, separating the magnet arrangement jig from between the OD alignment jig and the ID alignment jig, when all of the plurality of assembly magnets are assembled in the arrangement groove, and performing a bonding work of fixing the plurality of assembly magnets disposed in the arrangement groove.

### CROSS-REFERENCE TO RELATED APPLICATIONS

This application claims priority to and the benefit of Korean Patent Application No. 10-2024-0157700 filed with the Korean Intellectual Property Office on Nov. 8, 2024, the entire contents of which is incorporated herein by reference.

### TECHNICAL FIELD

The present disclosure relates to a method and apparatus for assembling Halbach array by utilizing a permanent magnet jig device, and more particularly, the present disclosure relates to a method and apparatus for assembling Halbach array by utilizing a permanent magnet jig device, which is applicable to manufacturing of a rotor of a drive motor of an electric vehicle.

### BACKGROUND

Typically, a drive motor of an electric vehicle (EV) may include a stator configured to receive electrical energy from a battery and generate a rotating magnetic field and a rotor rotating by the rotating magnetic field generated by the stator.

The rotor receives power and converts the rotating magnetic field generated by the stator into driving energy, and to this end, has a structure in which magnets are arranged on a circumference of a cylindrical rotor (rotor hub). In this case, the plurality of magnets can be assembled in a circular Halbach array format in order to amplify a magnetic field in a direction in which the stator is present.

Such a Halbach array method has an advantage of being able to strengthen the magnetic field of the magnets, but from a manufacturing perspective, it has a disadvantage of being difficult to assemble due to the mutual repulsive force when assembling the magnetized magnets to the rotation member.

For example, the conventional Halbach array method includes a magnetized permanent magnet assembling method and a non-magnetized permanent magnet assembling method.

The magnetized permanent magnet assembling method is an assembly method of bonding the permanent magnets, of which an arrangement is difficult due to the magnetized magnetic force causing the implementation of automation to be also difficult, to the rotation member one by one manually.

However, in the case of the former, since the magnetized permanent magnets are individual bonded one by one, a significant of time is required for the bond to harden, which cases a drawback of deteriorating the productivity of manufacturing rotors. In addition, the permanent magnets may flow due to the repulsive force before the bond is hardened, which causes a drawback of being difficult to optimize the magnetic direction. In addition, it is difficult to solve a scattering problem during rotation with only the bonding between the permanent magnets, which causes a drawback of requiring a separate cover ring (e.g., made of carbon fiber reinforced plastic, aramid fiber, metal sleeve, or the like).

The non-magnetized permanent magnet assembling method is a method in which the non-magnetized magnet material is first assembled to a rotation member and then is magnetized by applying an external magnetic field.

However, in this case, there is a drawback in that, when magnetized after assembling, a magnetization degree of a portion where the position of the magnet material and the magnetic field do not coincide with each other (e.g., a tangential direction of the rotation member) is deteriorated, so that the permanent magnet magnetization rate is inferior to the method of assembling the magnetized permanent magnets. In addition, in the case of the latter, the non-magnetized magnet material is not distinguishable through Gauss or flux measurement. For this reason, the magnet manufacturer frequently applies epoxy coating different colors for distinction, which causes an increase of cost. In addition, when the coating is made with a wrong color, a problem of incorrect assembly is caused, and in this case, this may not be corrected at the time point of having finished the bonding after the magnetization even if the problem is confirmed, which increases the sunk cost.

The above information disclosed in this Background section is only for enhancement of understanding of the background of the disclosure, and therefore it may contain information that does not form the prior art that is already known in this country to a person of ordinary skill in the art.

### SUMMARY

The present disclosure attempts to provide a method for assembling a Halbach array by utilizing a permanent magnet jig device, and a jig device used therein, capable of capable of significantly reducing the manufacturing time of a rotor for a motor and securing quality balance by preventing the problem of incorrect assembly, by assembling a large number of assembly magnets in a magnet arrangement jig according to their orientation by utilizing a permanent magnet assembling jig disposed in a cylindrical two-stage structure, and performing a bonding work in the assembled state.

A method for assembling a Halbach array by utilizing a permanent magnet jig device may include inserting a magnet arrangement jig between an OD alignment jig including a plurality of permanent magnets disposed in a cylindrical form and forming a magnetic field in a radial direction and a tangential direction, and an ID alignment jig paired with the OD alignment jig, assembling a plurality of assembly magnets in an arrangement groove formed along an exterior circumference of the magnet arrangement jig according to an orientation of a Halbach array, separating the magnet arrangement jig from between the OD alignment jig and the ID alignment jig, when all of the plurality of assembly magnets are assembled in the arrangement groove, and performing a bonding work of fixing the plurality of assembly magnets disposed in the arrangement groove.

In the assembling of the assembly magnets according to the orientation of the Halbach array, the assembly magnet may be assembled by using one of a magnetized assembly magnet and a non-magnetized assembly magnet.

The assembling of the assembly magnets according to the orientation of the Halbach array may include detecting the assembly magnet having failed to be positioned at a correct position due to a mismatch between a magnetic field direction of the permanent magnet and an orientation of the assembly magnet.

The detecting of the magnet having failed to be positioned at a correct position may include checking a magnetized direction or the orientation of the assembly magnet by locating the assembly magnet on a reference magnet.

In the assembling of the assembly magnets according to the orientation of the Halbach array, the assembly magnet is assembled in one arrangement method of an 8-part unit, a 6-part unit, and a 4-part unit.

The assembling of the assembly magnets according to the orientation of the Halbach array may include sequentially assembling the assembly magnets according to a priority group that considers a magnetic field direction formed at the magnet arrangement jig.

The assembling of the assembly magnets according to the orientation of the Halbach array may include assembling the plurality of assembly magnets having a first polarity that is the same as that of the magnetic field in the radial direction in the magnet arrangement jig, assembling the plurality of assembly magnets having a second polarity opposite to the first polarity based on the magnetic field in the radial direction, assembling the plurality of assembly magnets having the magnetic field in the tangential direction, and assembling the plurality of assembly magnets having directionality other than directionalities of the radial direction and the tangential direction.

The assembling of the plurality of assembly magnets may include first assembling the assembly magnets having a polarity of a same direction and then assembling the assembly magnets having a polarity of an opposite direction.

In the assembling of the plurality of assembly magnets having a directionality other than directionalities of the radial direction and the tangential direction, the assembly magnets having a polarity of a diagonal direction formed of a magnetic field of a neighboring radial direction and tangential direction may be assembled.

The bonding work may include injecting resin into the assembly magnets arranged within the arrangement groove, coupling an upper cover to the magnet arrangement jig to which the injection of the resin is completed, inserting the assembly magnet into a vacuum chamber, and performing a bubble-removing work on the assembly magnet at a predetermined pressure condition, and inserting the magnet arrangement jig for which the bubble-removing work is completed into an oven, and performing hardening according to a predetermined resin hardening condition.

A permanent magnet jig device for Halbach array assembling may include an OD alignment jig in which a plurality of permanent magnets are disposed in a cylindrical form, to form a magnetic field of a radial direction and a tangential direction, an ID alignment jig paired with the OD alignment jig and in which the plurality of permanent magnets are disposed in a cylindrical form, and a magnet arrangement jig inserted between the OD alignment jig and the ID alignment jig, and configured to generate a Halbach array permanent magnet in a ring shape through a bonding work while a plurality of assembly magnets are assembled in an arrangement groove formed on an exterior circumference according to an orientation of the Halbach array.

The OD alignment jig may be configured to locate the assembly magnet at a correct position, when assembling the plurality of assembly magnets in the magnet arrangement jig.

The ID alignment jig may be configured to form a magnetic field in the same direction as the OD alignment jig, to align the assembly magnet assembled in the magnet arrangement jig at a correct position, and to increase a fixing force of the assembly magnet in cooperation with the OD alignment jig.

The assembly magnet may use a magnetized magnet or a non-magnetized magnet, and is assembled in one arrangement method of an 8-part unit, a 6-part unit, and a 4-part unit.

The permanent magnet jig device may further include a base formed with an insertion groove for insertion of the magnet arrangement jig on an upper surface, where the OD alignment jig and the ID alignment jig is installed in parallel to the upper surface of the base based on a rotation axis.

The magnet arrangement jig may include an upper cover configured to fix the plurality of assembly magnets assembled in the arrangement groove when performing the bonding work.

The upper cover may be located on a top of the assembly magnet assembled in the arrangement groove, to form a flowable space so that resin remaining after filling an empty space may rise when performing the bonding work.

The flowable space may be formed in a tapered shape so that the resin hardened in an oven can be separated.

The magnet arrangement jig may include a support block located on assembly magnets lower end assembled in the arrangement groove, and in which a fluid passage of a resin injected during the bonding work is formed.

According to an embodiment, by utilizing the permanent magnet jig device of the two-stage structure provided on the sides of the outer diameter (OD) and the inner diameter (ID) of the magnet arrangement jig, the magnetized magnets and the non-magnetized magnets may be assembled according to the alignment direction without distinction, and by performing the bonding by utilizing that state assembled in the magnet arrangement jig, assembling time may be reduced and the Halbach array permanent magnet of an integral ring structure may be manufactured in a uniform quality.

In addition, when assembling the assembly magnets in the magnet arrangement jig, the direction or orientation of magnetism may be checked by using a reference magnet according to an error proofing method, so that the problem of incorrect assembly may be fundamentally removed, thereby securing uniformity in product quality.

In addition, by decreasing the scattering problem of the assembly magnets by strengthening the bonding force, the cost and man-hours may be reduced by not employing a separate sleeve (a cover ring).

In addition, by using a Halbach array permanent magnet modularized in an integral ring structure, when a rotor for a motor of an electric vehicle is later manufactured, the assembling becomes simple with a center of the rotation axis, and accordingly, an improvement of the yield and productivity of the product may be expected.

### BRIEF DESCRIPTION OF THE DRAWINGS

FIG. 1 is a perspective view showing a configuration of a permanent magnet jig device according to an embodiment.

FIG. 2 is a top plan view showing a permanent magnet jig device according to an embodiment.

FIG. 3 shows an enlarged view of portion “A” in FIG. 2.

FIG. 4 shows a cross-sectional view of a permanent magnet jig device according to an embodiment.

FIG. 5A and FIG. 5B show an arrangement space implemented according to the shape of the permanent magnets used according to an embodiment.

FIG. 6 is a flowchart schematically showing a method for assembling Halbach array by utilizing a permanent magnet jig device according to an embodiment.

FIG. 7 shows a process in which a plurality of assembly magnets according to an embodiment are assembled according to the orientation.

FIG. 8A and FIG. 8B are drawings for explaining the concept of error proofing according to an embodiment.

FIG. 9 is a cross-sectional view showing a bonding process flow of permanent magnets according to an embodiment.

FIG. 10 shows a structure in which an upper cover is coupled to a magnet arrangement jig, when performing a bonding work according to an embodiment.

FIG. 11A and FIG. 11B show examples of arranging inner/outer diameter permanent magnets of a permanent magnet jig device according to another embodiment.

### DETAILED DESCRIPTION OF ILLUSTRATIVE EMBODIMENTS

The present disclosure will be described more fully hereinafter with reference to the accompanying drawings, in which exemplary embodiments of the disclosure are shown.

The terminology used herein is for the purpose of describing particular embodiments only and is not intended to be limiting of the present disclosure. As used herein, the singular forms are intended to include the plural forms as well, unless the context clearly indicates otherwise. It will also be understood that the terms “comprises” and/or “comprising” when used herein, specify the presence of mentioned features, integers, steps, actions, elements and/or components, but do not exclude the presence or addition of one or more of other features, integers, steps, actions, elements, components, and/or groups thereof. As used herein, the term “and/or” includes any one or all combinations of one or more related items.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the term.

In this specification, it is to be understood that when one component is referred to as being “connected” or “coupled” to another component, it may be connected or coupled directly to the other component or be connected or coupled to the other component with a further component intervening therebetween. In this specification, it is to be understood that when one component is referred to as being “connected or coupled directly” to another component, it may be connected to or coupled to the other component without another component intervening therebetween.

Throughout the specification, the terms used herein are only used to describe certain embodiments and are not intended to limit the present disclosure. Singular expressions are intended to include plural forms as well, unless the context clearly dictates otherwise.

Hereinafter, a method for assembling Halbach array by utilizing a permanent magnet jig device according to an embodiment, and a jig device used therein will be described in detail with reference to the drawings.

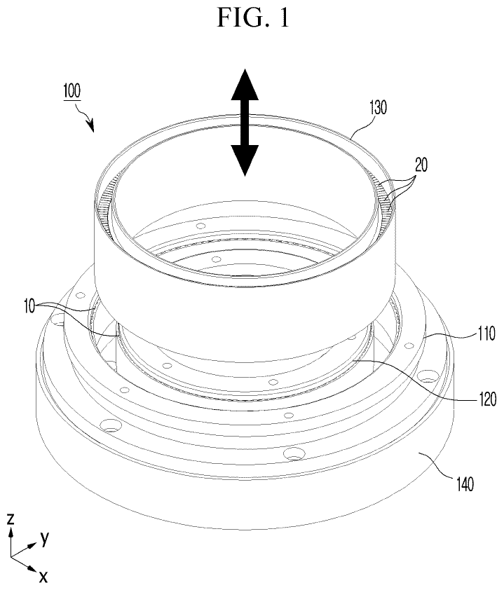

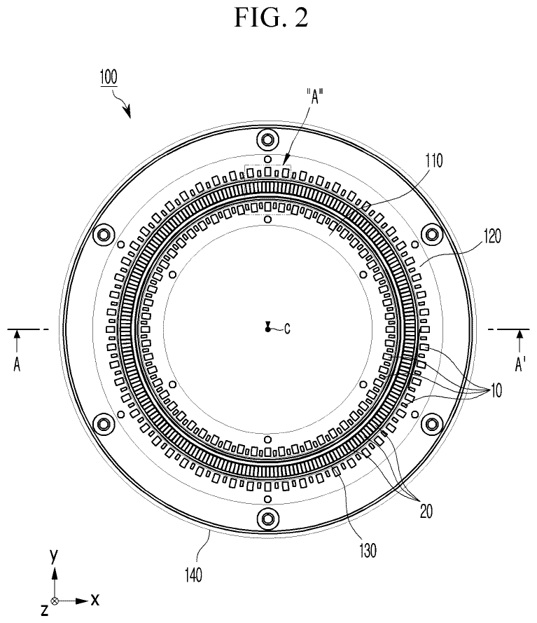

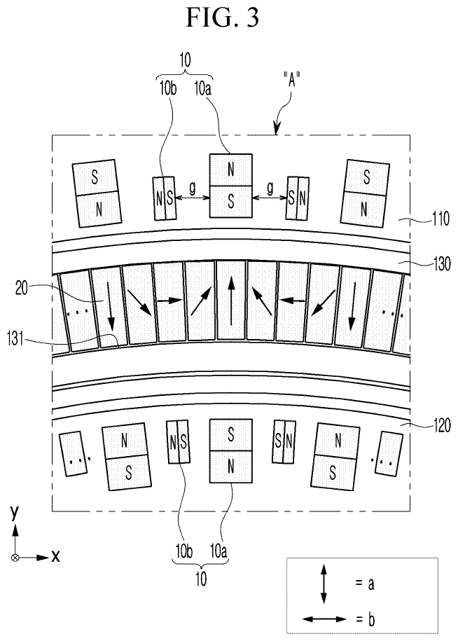

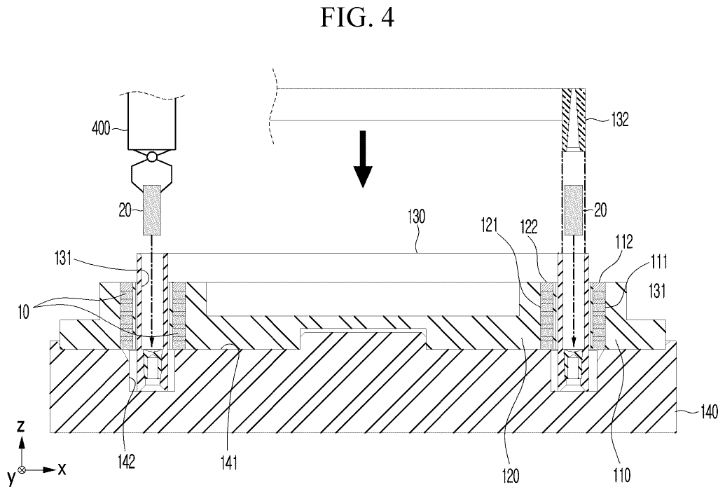

FIG. 1 is a perspective view showing a configuration of a permanent magnet jig device according to an embodiment. FIG. 2 is a top plan view showing a permanent magnet jig device according to an embodiment, and FIG. 3 shows an enlarged view of portion “A” in FIG. 2. In addition, FIG. 4 shows a cross-sectional view of a permanent magnet jig device according to an embodiment.

Referring to FIG. 1 to FIG. 4, a permanent magnet jig device 100 according to an embodiment may include an outer diameter (OD) alignment jig 110 in which a plurality of permanent magnets 10 are disposed in a cylindrical form, to form a magnetic field in a radial direction a and a tangential direction b (as shown in FIG. 3), an inner diameter (ID) alignment jig 120 paired with an OD alignment jig 110 and in which the plurality of permanent magnets 10 are disposed in a cylindrical form, and a magnet arrangement jig 130 inserted between the OD alignment jig 110 and an ID alignment jig 120 in a cylindrical form, and configured to generate a Halbach array permanent magnet 20 in a ring shape through a bonding work while a plurality of assembly magnets 20 are assembled in an arrangement groove 131 formed on an exterior circumference according to an orientation of a Halbach array based on a rotation axis (or, center axis) c.

The permanent magnet jig device 100 of the present disclosure may be referred to as “a permanent magnet jig device in a two-stage (or dual) structure”, considering the characteristics that the OD alignment jig 110 and an ID alignment jig 120 are configured on the outer diameter (OD) and inner diameter (ID) sides of the magnet arrangement jig 130, respectively. That is, the present disclosure may manufacture the Halbach array permanent magnet 20 by assembling and bonding the plurality of assembly magnets 20 according to the orientation of the Halbach array by utilizing the permanent magnet jig device 100 in a two-stage structure.

When assembling the plurality of assembly magnets 20 in the magnet arrangement jig 130, the OD alignment jig 110 may check whether the assembly magnet 20 is incorrectly assembled, i.e., whether the magnetic field direction and the orientation of the assembly magnet mismatches with each other, and may serve to locate (or, fix) the assembly magnet 20 at a correct position (or, reference position).

The ID alignment jig 120 may form a magnetic field in the same direction (a, b direction) as the OD alignment jig 110, to align the assembly magnet 20 assembled in the magnet arrangement jig 130 in the correct position (or, reference position), and to increase the fixing force of the assembly magnet 20 in cooperation with the OD alignment jig 110.

The OD alignment jig 110 and the ID alignment jig 120 may be installed in parallel to the upper surface of a base 140 based on a rotation axis c (e.g., as shown in FIG. 2).

As shown in FIG. 4, an insertion groove 142 for insertion of the magnet arrangement jig 130 may be formed on an upper surface 141 of the base 140.

Referring to FIG. 3, an 8-part arrangement state of the Halbach array method according to an embodiment is shown.

The permanent magnet 10 disposed inside the OD alignment jig 110 and the ID alignment jig 120 may include a first magnet 10a forming a magnetic field in the radial direction a and a second magnet 10b forming a magnetic field in the tangential direction b.

Considering the arrangement space, the second magnet 10b may be formed to be smaller than the first magnet 10a.

The assembly magnet 20 may use a magnetized magnet or a non-magnetized magnet.

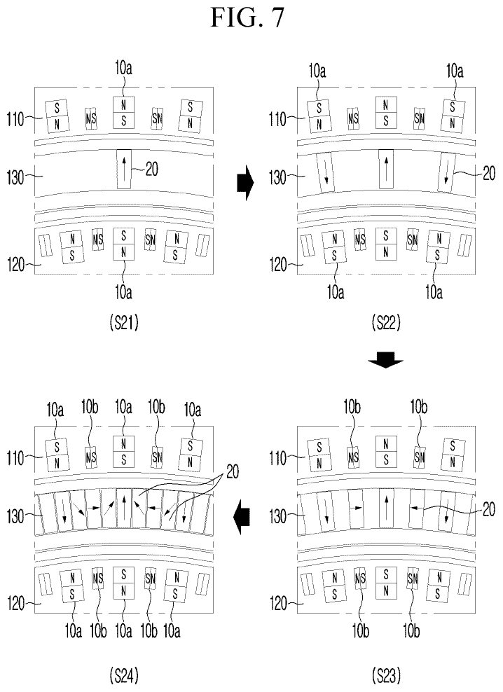

The assembly magnets 20 may be sequentially assembled according to a priority group consider the magnetic field direction formed at the magnet arrangement jig 130 by the OD alignment jig 110 and the ID alignment jig 120 (see FIG. 7).

The first magnet 10a may be disposed in a pair at the opposite (corresponding) positions of the OD alignment jig 110 and the ID alignment jig 120, and may be disposed in a symmetrical structure, so that the polarities N and S of the outer diameter (OD) and the inner diameter (ID) may become opposite to each other. Therefore, the outer diameter (OD) and the inner diameter (ID) may be paired, so as to effectively form the magnetic field in the radial direction a.

In the same way, the second magnet 10b may be disposed in a pair at the opposite (corresponding) positions of the OD alignment jig 110 and the ID alignment jig 120, to effectively form the magnetic field in the tangential direction b. The second magnet 10b has a smaller magnetic field than the radial direction a due to spatial constraints, but has a sufficient level to fix the orientated and/or magnetized assembly magnet 20 in the tangential direction b and serve to prevent incorrect assembly.

In addition, the first magnet 10a and the second magnet 10b are paired as a unit of magnetization position of each individual assembly magnet 20, and the magnets 10a, 10b, 10a, . . . , and the like neighboring on both sides may be disposed with an interval g of one unit (i.e., one assembly magnet).

The OD alignment jig 110 and the ID alignment jig 120 may include arrangement structures 111 and 121 (as shown in FIG. 4) for arranging the permanent magnet 10, and fixing portions 112 and 122 (as shown in FIG. 4) for preventing detachment of the arranged permanent magnet 10.

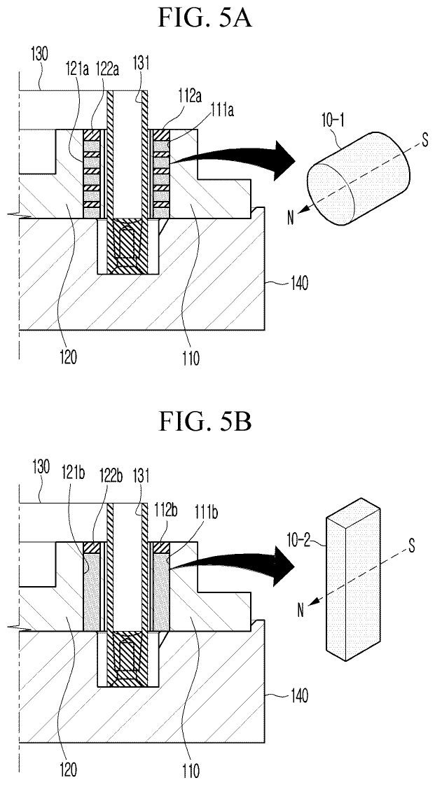

At this time, the arrangement structures 111 and 121 may implement at least one of a cylindrical magnet 10-1 (as shown in FIG. 5A) and a rectangular rod magnet 10-2 (as shown in FIG. 5B) as a usable structure according to a shape of the permanent magnet 10.

For example, FIG. 5A and FIG. 5B show an arrangement space implemented according to the shape of the permanent magnets used according to an embodiment.

Referring to FIG. 5A, a cross-sectional view of first arrangement structures 111a and 121a and their first fixing portions 112a and 122a corresponding to the cylindrical magnet 10-1 is shown.

The first arrangement structures 111a and 121a may form a multi-layer structure partitioned in order to arrange a plurality of cylindrical magnets 10-1 in a vertical direction. Although the cylindrical magnet 10-1 has an advantage of low cost compared to the rectangular rod magnet 10-2, they cannot be completed attached to each other by the magnetic force between the individual cylindrical magnets 10-1.

Referring to FIG. 5B, a cross-sectional view of second arrangement structures 111b and 121b and their second fixing portions 112b and 122b corresponding to the rectangular rod magnet 10-2 is shown.

The second arrangement structures 111b and 121b for fixing the rectangular rod magnet 10-2 has a space that can accommodate one rectangular rod magnet 10-2 in the vertical direction. The rectangular rod magnet 10-2 enables inserting a larger number of magnetic bodies to be inserted into the same volume. Therefore, it may be used for the strengthening/reinforcement of the magnetic force, or may be changed.

While the magnet arrangement jig 130 is inserted between the OD alignment jig 110 and the ID alignment jig 120, the assembly magnet 20 of the orientation corresponding to the magnetic field formed in the arrangement groove 131 may be assembled.

The magnet arrangement jig 130 may include an upper cover 132 (as shown in FIG. 4) configured to fix the plurality of assembly magnets 20 assembled in the arrangement groove 131. The upper cover 132 may be coupled to an upper portion of the magnet arrangement jig 130, to fix the plurality of assembly magnets 20 assembled in the arrangement groove 131 so as not to be detached or move.

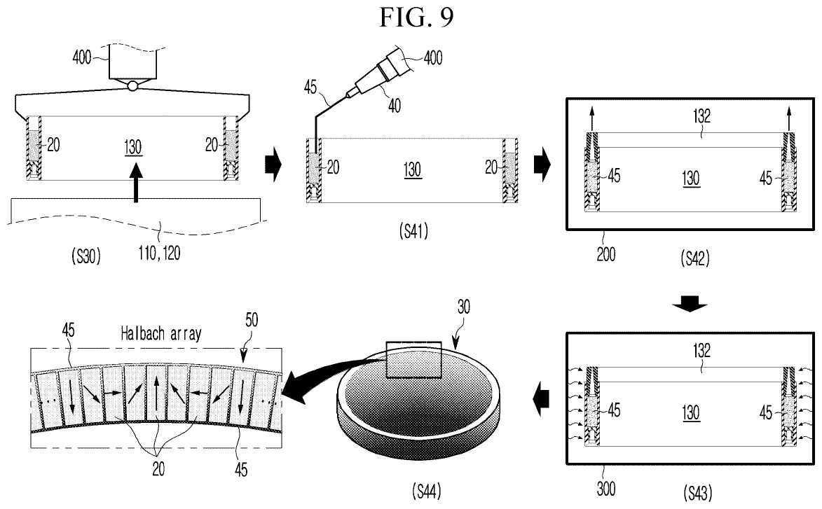

In the above description, the permanent magnet jig device 100 may automate an assembly process by using an automation equipment 400 (as shown in FIG. 9) including an articulated robot or an actuator device for each process. For example, the magnet arrangement jig 130 may be inserted, separated, and transported through the automation equipment 400, and the assembly magnet 20 gripped by a gripper of a robot/actuator may be transported to and assembled in the arrangement groove 131.

Meanwhile, based on the configuration of the permanent magnet jig device 100 described above, a method for assembling Halbach array by utilizing a permanent magnet jig device according to an embodiment will be described.

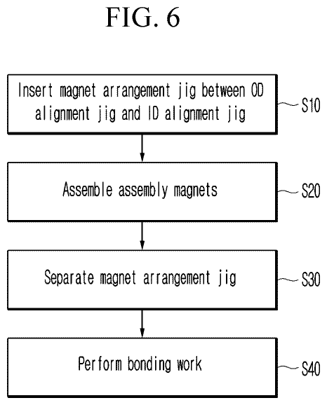

FIG. 6 is a flowchart schematically showing a method for assembling Halbach array by utilizing a permanent magnet jig device according to an embodiment.

Referring to FIG. 6, a method for assembling Halbach array by utilizing a permanent magnet jig device according to an embodiment may include the following processes.

The magnet arrangement jig 130 may be inserted between the OD alignment jig 110 in which the plurality of permanent magnets 10 are disposed in a cylindrical form, to form a magnetic field in the radial direction a and the tangential direction b, and the ID alignment jig 120 paired with the OD alignment jig 110, by the automation equipment 400, at step S10.

The plurality of assembly magnets 20 may be assembled in the arrangement groove 131 formed on an exterior circumference of the magnet arrangement jig 130 according to the orientation of the Halbach array by an automation equipment 400, at step S20.

When all the plurality of assembly magnets 20 are assembled in the arrangement groove 131, the magnet arrangement jig 130 may be separated from between the OD alignment jig 110 and the ID alignment jig 120 by the automation equipment 400, at step S30.

By performing a bonding work of fixing the plurality of assembly magnets 20 disposed in the arrangement groove 131 by the automation equipment 400, the Halbach array permanent magnet 20 in an integrated ring shape may be generated, at step S40.

Such a method for assembling Halbach array by utilizing a permanent magnet jig device 100 may assemble the assembly magnet 20 in the magnet arrangement jig 130 according to a predetermined orientation, and may significantly reduce the manufacturing time by bonding (and/or potting) the assembly magnet 20 assembled according to the predetermined orientation by utilizing the magnet arrangement jig 130. In addition, the problem due to incorrect assembly during the process of assembling the assembly magnet 20 in the magnet arrangement jig 130 may be fundamentally removed, thereby securing the uniformity of product quality. In addition, by strengthening the bonding force and reducing the problem of the assembly magnet 20 flying away, the cost and man-hours may be reduced due to eliminating the use of a separate sleeve (e.g., a cover ring).

FIG. 7 shows a process in which the plurality of assembly magnets according to an embodiment are assembled according to the orientation of the Halbach array.

Referring to FIG. 7, the assembly magnet 20 may be sequentially assembled according to the priority in consideration of the polarity of the permanent magnet 10 disposed in the OD alignment jig 110 and the ID alignment jig 120, and the magnetic field direction formed in the magnet arrangement jig 130. At this time, the assembly magnet 20 may be assumed to be a magnetized magnet.

First, in the magnet arrangement jig 130, the plurality of assembly magnets 20 having a first polarity ↑ that is the same as that of the magnetic field in the radial direction a may be preferentially assembled by the automation equipment 400, at step S21.

Subsequently, in the magnet arrangement jig 130, the plurality of assembly magnets 20 having a second polarity ↓ opposite to the first polarity ↑ based on the magnetic field in the radial direction a may be assembled by the automation equipment 400, at step S22.

Subsequently, in the magnet arrangement jig 130, the plurality of assembly magnets 20 having the magnetic fields → and ← in the tangential direction b may be assembled by the automation equipment 400, at step S23. At this time, as in the steps S21 to S22, the assembly magnets 20 having a polarity of the same direction in the tangential direction b (e.g., leftward direction or counterclockwise direction) may be first assembled, and afterwards, the assembly magnets 20 having a polarity of an opposite direction (e.g., rightward direction or clockwise direction) in the tangential direction b may be assembled.

In the assembling process of the assembly magnet 20, when the assembly magnet 20 having a different orientation from a direction of the external magnetic field is assembled, the assembly magnet 20 may not be positioned at the correct position (in other words, the assembly magnet 20 may not be positioned at the reference position according to the Halbach array). Therefore, when the assembly magnets 20 are assembled according to the orientation of the Halbach array, the assembly magnet 20 having failed to be positioned at the correct position due to a mismatch between the magnetic field direction of the permanent magnet and the orientation of the assembly magnets may be detected, thereby preventing the incorrect assembly of the assembly magnet 20. In addition, when the assembly magnet 20 is a non-magnetized magnet, the orientation of the Halbach array may not be considered, and the incorrect assembly of the assembly magnet 20 may be considered.

Finally, in the magnet arrangement jig 130, the plurality of assembly magnets 20 having directionalities other than the directionality (a and b) for strongly fixing by the magnetic field due to the permanent magnets of the external OD alignment jig 110 and the ID alignment jig 120 may be assembled, at step S24. For example, the assembly magnets 20 having polarities of diagonal directions □, □, □, □, formed of a magnetic field of a neighboring radial direction a and tangential direction b may be assembled. In addition, the assembly magnets 20 having a polarity of the same diagonal direction (e.g., right-upward diagonal direction) may be first assembled, and afterwards, the assembly magnet 20 having a polarity of an opposite direction (e.g., right-downward diagonal direction) may be assembled.

At this time, in the case of the assembly magnet 20 of the step S24 having the diagonal direction polarity, error proofing may be performed to prevent incorrect assembly.

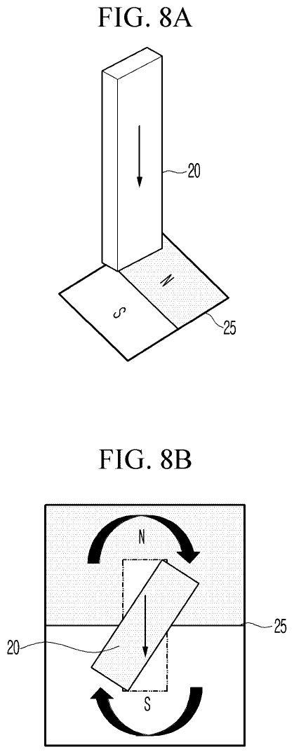

FIG. 8A and FIG. 8B are drawings for explaining the concept of error proofing according to an embodiment.

Referring to FIG. 8A, error proofing refers to a method of checking the magnetized direction or orientation by locating the assembly magnet 20 on a reference magnet 25 prepared in order to distinguish the polarity of the assembly magnet 20.

The reference magnet 25 may be a ferrite magnet rather than a permanent magnet, and when a reference magnet having strong magnetic field is used, it may cause a decrease in the magnetization rate of a non-magnetized assembly magnet 20. The error proofing is a method that can accurately distinguish the polarity of the assembly magnet 20 while minimizing the cross-section in contact with the reference magnet 25.

Referring to FIG. 8B, as the assembly magnet 20 rotates around a center of the N pole and S pole of the reference magnet 25, the magnetized direction or orientation of the assembly magnet 20 may be known. In particular, in the case of the non-magnetized assembly magnet 20 to which only orientation is applied, the orientation may be known even with a weak magnetic field, so it does not affect the decrease in magnetization rate even when magnetized after assembly is completed.

For example, the assembly magnet 20 tends to coincide with the direction of magnetic field formed by the reference magnet 25. Therefore, when the assembly magnet 20 rotates around the N pole and S pole of the reference magnet 25 by the automation equipment 400, the assembly magnet 20 tends to rotate so that the direction of magnetic field formed by the reference magnet 25 coincide with the orientation of the assembly magnet 20.

By using a vision sensor, an image sensor, or a contact sensor by considering these characteristics, the orientation of the assembly magnet 20 may be identified, and the incorrect assembly (having different direction of magnetism or orientation) of the assembly magnet 20 may be prevented.

In addition, in the case of the non-magnetized magnet, the direction is not necessarily considered, but even in this case, when a magnet having a different orientation is assembled, it may not be positioned at the correct position, thereby preventing incorrect assembly.

FIG. 9 is a cross-sectional view showing a bonding work flow of permanent magnets according to an embodiment.

Referring to FIG. 9, the bonding process according to an embodiment may be performed after the magnet arrangement jig 130 in which the plurality of assembly magnets 20 are completely assembled is separated from between the OD alignment jig 110 and the ID alignment jig 120, at the step S30. When the magnet arrangement jig 130 is separated from the OD alignment jig 110 and the ID alignment jig 120, since a movement of the assembly magnet 20 may occur in the magnet arrangement jig 130 as the external magnetic field due to the permanent magnet disappears, care must be taken to prevent the assembly magnet 200 from becoming disoriented due to impact, or the like.

A resin 45 may be injected onto the assembly magnets 20 arranged within the arrangement groove 131 by using a dispenser 40, at step S41. At this time, the magnet arrangement jig 130 may be preheated depending on the property of the resin 45.

The upper cover 132 may be coupled to the magnet arrangement jig 130 to which the injection of the resin 45 is completed by the automation equipment 400, the assembly magnet 20 may be inserted into a vacuum chamber 200 by the automation equipment 400, and a bubble-removing work may be performed on the assembly magnet 20 at a predetermined pressure condition (e.g., −90 to −100 kPa), at step S42. Through the bubble-removing work, the resin 45 may be evenly spread between the arranged assembly magnets 20 and surrounding empty spaces, and internal bubbles may be discharged.

The magnet arrangement jig 130 for which the bubble-removing work is completed may be inserted into an oven 300 by the automation equipment 400, and may be hardened according to a predetermined resin 45 hardening condition (e.g., UV conditions), at step S43.

After the resin 45 is hardened, the integral Halbach array permanent magnet 20 formed in a ring shape may be separated from the arrangement jig 130 by the automation equipment 400, at step S44.

Since such a Halbach array permanent magnet 20 has a structure modularized in an integral ring structure, easy assembling may be achieved around the rotation axis c when manufacturing a rotor for a motor of an electric vehicle.

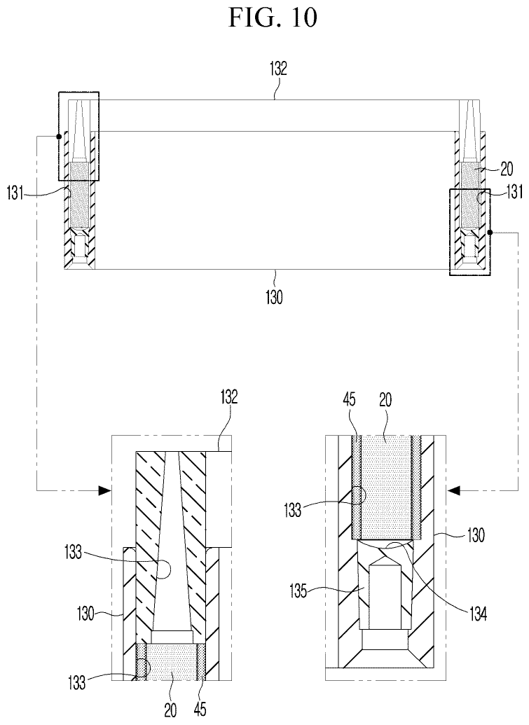

Meanwhile, FIG. 10 shows a structure in which an upper cover is coupled to a magnet arrangement jig, when performing a bonding work according to an embodiment.

Referring to FIG. 10, the upper cover 132 may be coupled to an upper portion of the assembly magnet 20 arranged within the arrangement groove 131, to serve a function of preventing a vertical movement, and may also be used as a device for resin expansion and bubble removing when performing the bonding (or potting) work.

The upper cover 132 may be located on the top of the assembly magnet 20, to form a flowable space 133 so that the resin 45 remaining after filling the empty space between the assembly magnets 20 may rise when performing the bonding work.

The flowable space 133 may be formed in a tapered shape (conical shape), so that the resin 45 having risen to the top of the assembly magnet 20 may be easily separated after being hardened in the oven.

The magnet arrangement jig 130 may be located on the assembly magnets 20 lower end assembled in the arrangement groove 131, and may include a support block 135 in which a fluid passage 134 of the resin 45 injected when performing the bonding work is formed.

The fluid passage 134 within the magnet arrangement jig 130 refers an empty space remaining between the arrangement groove 131 and the assembly magnets 20 arranged therein. This is a very narrow space, but is ultimately filled with the resin 45.

Therefore, the fluid passage 134 may serve to evenly spread the resin 45 by forming a passage connecting the arranged assembly magnets 20, so that the injected resin 45 may entirely fill the empty space. In addition, this may serve as an air discharge path when removing bubbles. In addition, the resin filled in the fluid passage 134 is in surface contact with the bonded assembly magnet 20, thereby minimizing damage due to local force.

While the exemplary embodiments of the present disclosure have been described hereinabove, the present disclosure is not limited only the exemplary embodiments and various other changes can be made.

For example, in the embodiment shown in FIG. 3, the permanent magnet jig device 100 of a two-stage structure in which the assembly magnets 20 are arranged by forming a magnetic field by the permanent magnets 10 corresponding to each other on the outer diameter (OD) and inner diameter (ID) sides of the magnet arrangement jig 130 has been mainly described.

However, an embodiment is not limited thereto, and a method in which the assembly magnet 20 are arranged by forming a magnetic field by the permanent magnet 10 disposed on one of the outer diameter (OD) and inner diameter (ID) sides may be applied.

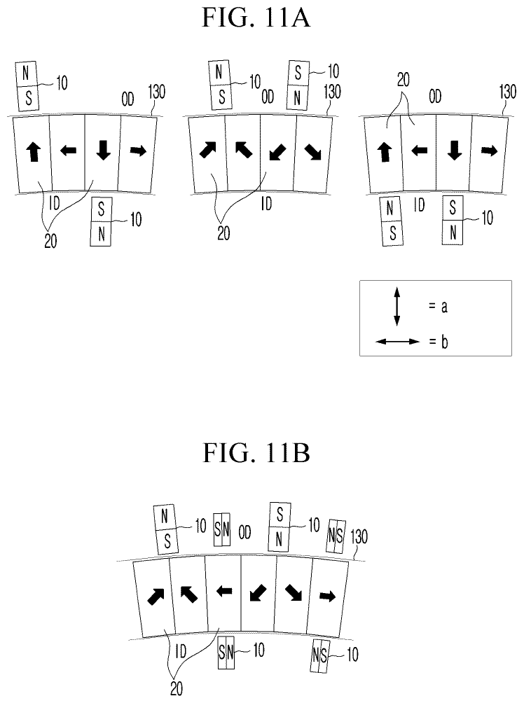

FIG. 11A and FIG. 11B show examples of arranging inner diameter and outer diameter permanent magnets of a permanent magnet jig device according to another embodiment.

Referring to FIG. 11A, an example of a method in which the assembly magnets 20 are arranged in 4-part units is shown.

When the assembly magnets 20 are arranged in 4-part units, the permanent magnets 10 may be disposed on only one side among the outer diameter (OD) and inner diameter (ID) sides of the magnet arrangement jig 130, to form the magnetic field in the radial direction a, and the permanent magnet 10 with respect to the tangential direction b is not disposed (unemployed). At this time, in the magnet arrangement jig 130, the plurality of assembly magnets 20 having the first polarity that is the same as that of the magnetic field in the radial direction a may be preferentially assembled, and afterwards, the plurality of assembly magnets 20 having the second polarity opposite to the first polarity may be assembled.

In addition, when the assembly magnets 20 are arranged in 4-part units, the permanent magnets 10 may be disposed on only one among the outer diameter (OD) and inner diameter (ID) sides of the magnet arrangement jig 130, to form the magnetic field in the radial direction a, and two assembly magnets 20 having the polarities of diagonal directions □, □, □, and □ symmetrical to each other may be assembled between the permanent magnet 10.

Referring to FIG. 11B, an example of a method in which the assembly magnets 20 are arranged in 6-part units is shown.

When the assembly magnets 20 are arranged in 6-part units, the permanent magnets 10 may be disposed on only one side among the outer diameter (OD) and inner diameter (ID) sides of the magnet arrangement jig 130, to form the magnetic field in the radial direction a, and the two assembly magnets 20 having the polarities of diagonal (oblique) directions symmetrical to each other may be assembled between the permanent magnet 10. In addition, the assembly magnet 20 may be assembled according to the position for forming the magnetic field in the tangential direction b by being disposed in a pair at the outer diameter (OD) and inner diameter (ID). The assembly magnet 20 assembled according to the magnetic field in the tangential direction b may be assembled between the two assembly magnets 20 in symmetrical diagonal directions.

Other features are similar to the above-described embodiment, and the redundant description is not included herein.

As such, according to an embodiment, by utilizing the permanent magnet jig device of the two-stage structure provided on the sides of the outer diameter (OD) and the inner diameter (ID) of the magnet arrangement jig, the assembly magnet 20 may be assembled according to the Halbach array alignment direction, regardless of the magnetized magnets and the non-magnetized magnets. In addition, by performing the bonding work by utilizing that state assembled in the magnet arrangement jig, the assembling time of the assembly magnet 20 can be reduced and a Halbach array permanent magnet of an integral ring structure can be manufactured in a uniform quality.

In addition, when assembling the assembly magnets in the magnet arrangement jig, the direction or orientation of magnetism may be checked through an error proofing method using a reference magnet, so that the problem of incorrect assembly of the assembly magnets may be fundamentally removed, thereby securing uniformity in product quality.

In addition, by decreasing the scattering problem of the assembly magnets by strengthening the bonding force, a separate sleeve (or, cover ring) may not be employed, and through this, the assemble cost and man-hours may be reduced.

In addition, by using a Halbach array permanent magnet modularized in an integral ring structure, when a rotor for a motor of an electric vehicle is manufactured, the assembling becomes simple with a center of the rotation axis c, and accordingly, an improvement of the yield and productivity of the product may be expected.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### Description of Symbols

10: permanent magnet
20: assembly magnet
25: reference magnet
30: Halbach array permanent magnet
40: dispenser
45: resin
100: permanent magnet jig device
110: outer diameter (OD) alignment jig
120: inner diameter alignment jig
130: the magnet arrangement jig
131: arrangement groove
132: upper cover
133: flowable space
134: fluid passage
135: support block
140: base
141: upper surface
142: insertion groove
200: vacuum chamber
300: oven

What is claimed is:

1. A method for assembling a Halbach array by utilizing a permanent magnet jig device, the method comprising:
inserting a magnet arrangement jig between an outer diameter (OD) alignment jig comprising:
a plurality of permanent magnets disposed in a cylindrical form and forming a magnetic field in a radial direction and a tangential direction; and
an inner diameter (ID) alignment jig paired with the OD alignment jig;
assembling a plurality of assembly magnets in an arrangement groove formed along an exterior circumference of the magnet arrangement jig according to an orientation of the Halbach array;
separating the magnet arrangement jig from between the OD alignment jig and the ID alignment jig, when all of the plurality of assembly magnets are assembled in the arrangement groove; and
performing a bonding work of fixing the plurality of assembly magnets disposed in the arrangement groove.

2. The method of claim 1, wherein, in the assembling of the plurality of assembly magnets according to the orientation of the Halbach array, each assembly magnet of the plurality of assembly magnets is assembled by using one of a magnetized assembly magnet and a non-magnetized assembly magnet.

3. The method of claim 1, wherein assembling the plurality of assembly magnets according to the orientation of the Halbach array comprises:
detecting an assembly magnet of the plurality of assembly magnets having failed to be positioned at a correct position due to a mismatch between a magnetic field direction of a permanent magnet of the plurality of permanent magnets and an orientation of the assembly magnet.

4. The method of claim 3, wherein detecting the assembly magnet having failed to be positioned at the correct position comprises:
checking a magnetized direction or the orientation of the assembly magnet by locating the assembly magnet on a reference magnet.

5. The method of claim 1, wherein, in the assembling of the plurality of assembly magnets according to the orientation of the Halbach array, the plurality of assembly magnets is assembled as an 8-part unit, a 6-part unit, or a 4-part unit.

6. The method of claim 1, wherein assembling the plurality of assembly magnets according to the orientation of the Halbach array comprises:
sequentially assembling the plurality of assembly magnets according to a priority group that considers a magnetic field direction formed at the magnet arrangement jig.

7. The method of claim 6, wherein assembling the plurality of assembly magnets according to the orientation of the Halbach array comprises:
assembling a first portion of the plurality of assembly magnets having a first polarity that is the same as that of the magnetic field in the radial direction in the magnet arrangement jig;
assembling a second portion of the plurality of assembly magnets having a second polarity opposite to the first polarity based on the magnetic field in the radial direction;
assembling a third portion of the plurality of assembly magnets having the magnetic field in the tangential direction; and
assembling a fourth portion of the plurality of assembly magnets having directionality other than directionalities of the radial direction and the tangential direction.

8. The method of claim 7, wherein assembling the plurality of assembly magnets comprises:
first assembling a subset of the plurality of assembly magnets having a polarity of a same direction and then assembling a second subset of the assembly magnets having a polarity of an opposite direction.

9. The method of claim 7, wherein, in the assembling of the plurality of assembly magnets having a directionality other than directionalities of the radial direction and the tangential direction, a fifth portion of the assembly magnets having a polarity of a diagonal direction formed of a magnetic field of a neighboring radial direction and tangential direction are assembled.

10. The method of claim 1, wherein performing the bonding work comprises:
injecting resin into the plurality of assembly magnets arranged within the arrangement groove;
coupling an upper cover to the magnet arrangement jig to which the injection of the resin is completed;
inserting the plurality of assembly magnets into a vacuum chamber;
performing a bubble-removing work on the plurality of assembly magnets at a predetermined pressure condition;
inserting the magnet arrangement jig for which the bubble-removing work is completed into an oven; and
performing hardening according to a predetermined resin hardening condition.

11. A permanent magnet jig device for Halbach array assembling, the permanent magnet jig device comprising:
an outer diameter (OD) alignment jig in which a plurality of permanent magnets is disposed in a cylindrical form, to form a magnetic field of a radial direction and a tangential direction;
an inner diameter (ID) alignment jig paired with the OD alignment jig and in which the plurality of permanent magnets are disposed in the cylindrical form; and
a magnet arrangement jig inserted between the OD alignment jig and the ID alignment jig, and configured to generate a Halbach array permanent magnet in a ring shape through a bonding work while a plurality of assembly magnets are assembled in an arrangement groove formed on an exterior circumference according to an orientation of a Halbach array.

12. The permanent magnet jig device of claim 11, wherein the OD alignment jig is configured to locate an assembly magnet of the plurality of assembly magnets at a correct position, when assembling the plurality of assembly magnets in the magnet arrangement jig.

13. The permanent magnet jig device of claim 12, wherein the ID alignment jig is configured to:
form a magnetic field in the same direction as the OD alignment jig;
align the assembly magnet assembled in the magnet arrangement jig at the correct position; and
increase a fixing force of the assembly magnet in cooperation with the OD alignment jig.

14. The permanent magnet jig device of claim 11, wherein each assembly magnet of the plurality of assembly magnets uses a magnetized magnet or a non-magnetized magnet, and the plurality of assembly magnets is assembled as an 8-part unit, a 6-part unit, or a 4-part unit.

15. The permanent magnet jig device of claim 11, further comprising a base formed with an insertion groove for insertion of the magnet arrangement jig on an upper surface, wherein the OD alignment jig and the ID alignment jig is installed in parallel to the upper surface of the base based on a rotation axis.

16. The permanent magnet jig device of claim 11, wherein the magnet arrangement jig comprises:
an upper cover configured to fix the plurality of assembly magnets assembled in the arrangement groove when performing the bonding work.

17. The permanent magnet jig device of claim 16, wherein the upper cover is located on a top of the plurality of assembly magnets assembled in the arrangement groove, to form a flowable space so that resin remaining after filling an empty space may rise when performing the bonding work.

18. The permanent magnet jig device of claim 17, wherein the flowable space is formed in a tapered shape so that the resin hardened in an oven can be separated.

19. The permanent magnet jig device of claim 11, wherein the magnet arrangement jig comprises:
a support block located on assembly magnets lower end assembled in the arrangement groove.

20. The permanent magnet jig device of claim 19, wherein the support block comprises a fluid passage of a resin injected during the bonding work.
